(19) United States
(12) Patent Application Publication
(10) Pub. No.: US 2025/0322329 A1
(43) Pub. Date: Oct. 16, 2025

(54) MATCHING SUPPORT SYSTEM AND MATCHING SUPPORT METHOD

(71) Applicant: Hitachi, Ltd., Tokyo (JP)

(72) Inventors: Manami IKEDA, Tokyo (JP); Kosuke ANZAI, Tokyo (JP); Hiroki UCHIYAMA, Tokyo (JP)

(21) Appl. No.: 18/867,211

(22) PCT Filed: Feb. 9, 2023
(86) PCT No.: PCT/JP2023/004317

§ 371 Date: Nov. 19, 2024

(30) Foreign Application Priority Data
May 25, 2022 (JP) 2022-085045

(51) Int. Cl. G06Q 10/0631; G06Q 50/20

(52) U.S. Cl. CPC G06Q 10/063112; G06Q 50/205

(57) ABSTRACT

A matching support system matches clients and service providers. The system stores information about service, request information received from a client of the service, reliability information indicating a degree of reliability of the providers, and information indicating expertise of the providers. The matching support system determines a difficulty level of the request based on the request information, extracts candidates of the providers of the service from the basic information to extract the provider having a higher reliability for the request having a higher difficulty level, and generates a first extraction result. The support system extracts candidates of the providers of the service from the first extraction result to extract the provider having higher expertise in the service for the request having a higher difficulty level, and generates a second extraction result. Thereby, the matching support system presents, to a user, candidates of the providers based on the second extraction result.

### TECHNICAL FIELD

The present invention relates to a matching support system and a matching support method.

### BACKGROUND ART

This application claims priority based on Japanese Patent Application No. 2022-085045, filed on May 25, 2022, the entire disclosure of which is incorporated herein by reference.

In the related art, various mechanisms have been proposed to support matching between a client and a person who provides a service (hereinafter referred to as a “service provider”) in a case where the client (service recipient) requests the service provider to provide the service.

For example, PTL 1 describes an education mediation processing device that evaluates levels of teachers in advance and introduces, to students, teachers who are suitable for levels of the students. The education mediation processing device evaluates the levels of the teachers recruited by teacher recruitment means, and mediates between the students and the teachers with evaluation levels corresponding to the levels of students recruited by student recruitment means. Further, the education mediation processing device conducts a predetermined test on the teachers and evaluates the levels of the teachers in accordance with the test results. Furthermore, the education mediation processing device extracts the teachers with the evaluation levels corresponding to the acquired levels of the students and allows a student to select a desired teacher from among the extracted teachers.

For example, PTL 2 describes a support system that matches a user who belongs to one of multiple pre-registered local communities with a supporter who supports the user, and supports mutual assistance activities between the user and the supporter. The support system manages support registration data that includes supporter information on each of a plurality of approved supporters approved by an administrator who manages a local community to which the supporter belongs, and selects a supporter candidate suitable for a support request from a user from the plurality of approved supporters included in the support registration data. Further, the support system preferentially selects supporter candidates with individual reliabilities determined by the administrator from among the plurality of approved supporters included in the support registration data.

### CITATION LIST

### Patent Literature

PTL 1: JP2002-183487A
PTL 2: JP2020-170424A

### SUMMARY OF INVENTION

### Technical Problem

In a case where a client makes a request to a service provider, the client selects an agent from the following viewpoint. For example, “I want to select an agent who can perform the service appropriately”, “I want to request an agent who will handle the service at a reasonable fee”, or “I want to request an agent who is familiar with the field of the service I want to request”. Meanwhile, from the viewpoint of work efficiency, work sharing, and education, a service provider has the following desire. “If a service provider has little experience (is not yet reliable), the service provider wants to gain experience in a wide range of services that do not require a high level of expertise (do not necessarily require expertise) in various service fields and increase reliability of the service provider while assessing the service provider's own expertise”. Alternatively, “if a service provider has a lot of experience, the service provider focuses on providing services for high level expertise to further improve the service provider's own expertise and increase reliability of the service provider”. It is desirable to consider not only the viewpoint of the client but also the viewpoint of the service provider in a case of matching between clients and service providers.

In PTL 1 mentioned above, the level of the teacher is evaluated in advance, and a teacher suitable for the level of the student is introduced to the student. Further, in PTL 2 mentioned above, the user selects a reliable supporter candidate based on the experience value and other information (such as presence or absence of qualifications) of the supporter candidate. However, neither of the mechanisms described in the patent literature performs matching between clients (students, users) and service providers (teachers, supporter candidates) after considering the viewpoint of the clients or the desire of the service provider.

An object of the present invention is to provide a matching support system and a matching support method capable of supporting appropriate matching between a client (service recipient) and a service provider.

### Solution to Problem

According to an embodiment of the present invention for achieving the above-mentioned object, provided is a matching support system that supports matching between a client and a provider of a service in a case where the client requests the provider of the service to provide the service, the matching support system being configured by using an information processing apparatus having a processor and a storage device, storing basic information that is information about each of a plurality of providers, request information that is information about a request received from the client, reliability that is information indicating a degree of reliability of each of the plurality of providers, and information that indicates expertise of each of the providers for the service, and comprising: a difficulty level determination portion that determines a difficulty level of the request based on the request information; a first extraction portion that extracts candidates of the providers of the service from the basic information so as to extract the provider having a higher reliability for the request having a higher difficulty level and that generates a first extraction result describing extracted results; and a second extraction portion that extracts candidates of the providers of the service from the first extraction result so as to extract the provider having higher expertise in the service for the request having a higher difficulty level and that generates a second extraction result describing extracted results.

Other problems and solutions disclosed in the present application will be clarified in the sections on embodiments for carrying out the invention and in the drawings.

### Advantageous Effects of Invention

According to the present invention, it is possible to support appropriate matching between the client (service recipient) and the service provider.

### BRIEF DESCRIPTION OF DRAWINGS

FIG. 1 is an example of a matching support system.

FIG. 2 is an example of functions provided in an agency request support device according to a first embodiment.

FIG. 3 is an example of a reliability determination table.

FIG. 4 is an example of a field-of-expertise determination table.

FIG. 5 is an example of a basic information table.

FIG. 6 is an example of an agency history table.

FIG. 7 is an example of a request status table.

FIG. 8 is a flowchart illustrating agency request support processing according to the first embodiment.

FIG. 9 is a flowchart illustrating an example of first extraction processing.

FIG. 10 is a flowchart illustrating an example of second extraction processing.

FIG. 11 is a flowchart illustrating an example of reliability determination table generation processing.

FIG. 12A is an example of a correspondence table between the numbers of applications and scores.

FIG. 12B is an example of a correspondence table between adoption rates and scores.

FIG. 12C is an example of a correspondence table between average values of client evaluations and scores.

FIG. 13 is a flowchart illustrating an example of field-of-expertise determination table generation processing.

FIG. 14A is an example of a field-of-expertise reception screen.

FIG. 14B is an example of a capability information confirmation screen.

FIG. 15 is an example of a request evaluation reception screen.

FIG. 16 is an example of an information processing apparatus used for a configuration of the matching support system.

FIG. 17 is an example of functions provided in an agency request support device according to a second embodiment.

FIG. 18A is a diagram illustrating a situation where a difficulty level determination portion generates a difficulty level determination result.

FIG. 18B is a diagram illustrating a situation where a workload determination portion generates a workload determination result.

FIG. 19 is an example of a work schedule reception screen.

FIG. 20 is an example of a workload determination table.

FIG. 21 is a flowchart illustrating agency request support processing according to the second embodiment.

FIG. 22 is a flowchart illustrating third extraction processing.

FIG. 23 is a diagram illustrating a brief overview of third extraction result generation processing.

FIG. 24 is a flowchart illustrating the third extraction result generation processing.

FIG. 25 is a flowchart illustrating fourth extraction result generation processing.

FIG. 26 is an example of functions provided in an agency request support device according to a third embodiment.

FIG. 27 is an example of a desired client level reception screen.

FIG. 28 is an example of a basic information table.

FIG. 29 is an example of a client evaluation table.

### DESCRIPTION OF EMBODIMENTS

Hereinafter, embodiments of the present invention will be described, with reference to the drawings. It should be noted that the following description and drawings are examples for describing the present invention, and are not given and simplified as appropriate for clarity of description. The present invention can also be implemented in various other forms.

In the following description, in a case of describing identification information, such expressions as “identifier”, “name”, “ID”, and “number” are used, but these can be substituted for each other. Further, in the following description, various kinds of information may be described using such expressions as “table” and “information”, but the various kinds of information may be expressed in a data structure other than these. In order to indicate that the “table” and “information” do not depend on the data structure, an “XX table” may be referred to as “XX information”. Furthermore, in the following description, “database” may be referred to as “DB”. Moreover, in the following description, repeated descriptions of identical or similar configurations may not be given. In addition, in the following description, the letter “S” before a reference symbol indicates a processing step.

### First Embodiment

Hereinafter, an information processing system according to an embodiment of the present invention (hereinafter referred to as a “matching support system 1”) will be described. The matching support system 1 supports matching between a client and a person who provides a service (hereinafter referred to as “service provider”) in a case where the client requests the service provider to provide a service. In addition, the clients and service providers targeted by the matching support system 1 are not necessarily limited. In the following, a description will be given of an example of a case where the client is an individual or a company and the service provider is a person who performs services related to the processing of various applications made to national or local government institutions (for example, the agent is a professional such as a lawyer, judicial scrivener, or administrative scrivener; hereinafter referred to as the “agent”).

In a case where the client requests the service from the agent, the client selects an agent from the following viewpoint. For example, “I want to select an agent who can perform the service appropriately”, “I want to request an agent who will handle the service at a reasonable fee”, or “I want to request an agent who is familiar with the field of the service I want to request”. Meanwhile, the agent has the following desire. “A service provider having insufficient experience (low reliability) gains a wide range of experience in services that do not require a high level of expertise (do not necessarily require expertise) in various service fields and increase reliability of the service provider while assessing the service provider's own expertise”. Alternatively, “a person having a lot of experience focuses on providing services for high level expertise to further improve the person's own expertise and increase reliability of the service provider”. The matching support system 1 provides a mechanism for recommending agent candidates suitable for providing the service requested by the client in consideration of all of the viewpoints of the client and the thoughts of the agent. In a case of making a recommendation, the matching support system 1 selects an agent to be recommended, in consideration of, for example, the agent's capabilities and reliability, the content of the requested service, and the cost. Further, the matching support system 1 selects an appropriate agent, in consideration of, for example, the actual business situation of the agent (diversification of business content, difficulty in keeping up with the latest information, separation based on the expertise of the agent, differences in the difficulty level of each business, ensuring an educational opportunity for an unskilled person for career advancement, ensuring a profit commensurate with the service, and the like).

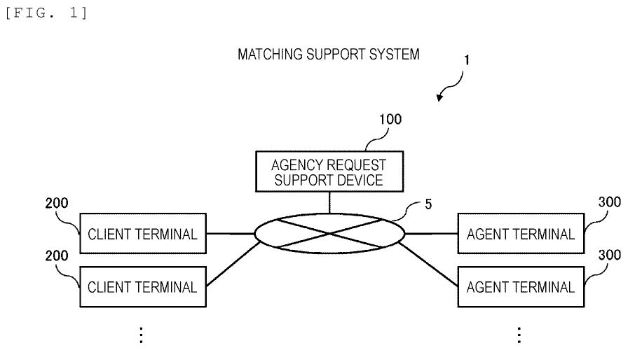

FIG. 1 illustrates a schematic configuration of the matching support system 1. As illustrated in the drawing, the matching support system 1 includes an agency request support device 100, a client terminal 200, and an agent terminal 300. The agency request support device 100, the client terminal 200, and the agent terminal 300 are each configured using one or more information processing apparatuses (computers), and are connected in a state where two-way communication is possible via a communication network 5. The communication network 5 is a wired or wireless communication network, and includes, for example, a local area network (LAN), a wide area network (WAN), the Internet, various public wireless communication networks, a dedicated line, and the like.

The agency request support device 100 receives information about an agency request (hereinafter referred to as “request information”) for the service from the client terminal 200, and selects an agent to perform the agency services designated in the request information based on the received request information. Then, the agency request support device 100 generates information (hereinafter referred to as “recommendation information”) describing the selected agent and transmits the information to the client terminal 200.

The client terminal 200 receives a request content from the client, generates request information describing the received request contents, and transmits the information to the agency request support device 100. Further, the client terminal 200 receives the recommendation information from the agency request support device 100 and presents the received recommendation information to the client.

The agent terminal 300 receives information (hereinafter referred to as “agent information”), which is used by the agency request support device 100 in a case of selecting an agent, from the agent, and transmits the received agent information to the agency request support device 100.

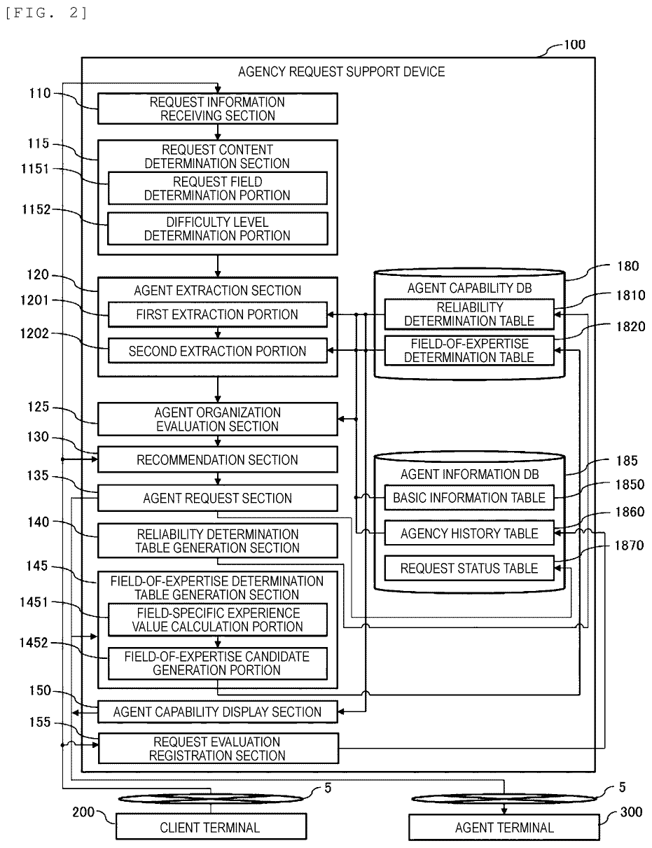

FIG. 2 is a diagram illustrating main functions of the agency request support device 100. As illustrated in the drawing, the agency request support device 100 has respective functions of a request information receiving section 110, a request content determination section 115, an agent extraction section 120, an agent organization evaluation section 125, a recommendation section 130, an agent request section 135, a reliability determination table generation section 140, a field-of-expertise determination table generation section 145, an agent capability display section 150, a request evaluation registration section 155, an agent capability DB 180, and an agent information DB 185.

As illustrated in the drawing, the agent capability DB 180 manages a reliability determination table 1810 and a field-of-expertise determination table 1820. Further, the agent information DB 185 manages a basic information table 1851, an application history table 1852, and a request status table 1870.

Among the above-mentioned functions, the request information receiving section 110 receives and stores the request information sent from the client terminal 200. The request information includes information for specifying the client (hereinafter referred “client ID”), information about the specific contents of the requested service, and various kinds of information required for the execution of the service.

The request content determination section 115 has a request field determination portion 1151 and a difficulty level determination portion 1152. Of these, the request field determination portion 1151 determines a field of the requested service (such as the type of application, hereinafter referred to as a “request field”), based on the request information. For example, in a case where the request information includes information indicating the request field, the request field determination portion 1151 determines the request field using the information. Further, for example, the request field determination portion 1151 determines the request field by applying a category classification algorithm or natural language processing to the description (text data, and the like) included in the request information.

The difficulty level determination portion 1152 determines a difficulty level of the request (the difficulty level of the service to be provided in response to the request), based on the request information. The difficulty level determination portion 1152 determines the difficulty level, based on, for example, the effort required to provide the service in response to the request, the amount of processing, the complexity of the work, the required period (deadline), and the like. In the present embodiment, the difficulty level is either “low”, “medium”, or “high”, but the difficulty level may be, for example, a continuous value (a continuous value in which the larger the value, the higher the difficulty level). For example, in a case where the request information includes information indicating the difficulty level, the difficulty level determination portion 1152 determines the difficulty level using the information. Further, for example, the difficulty level determination portion 1152 determines the difficulty level by applying a predetermined algorithm or natural language processing to the description (text data, and the like) included in the request information.

The agent extraction section 120 has a first extraction portion 1201 and a second extraction portion 1202. Of these, the first extraction portion 1201 refers to the reliability determination table 1810, extracts agents from the basic information table 1851 in terms of reliability, and generates information (hereinafter referred to as the “first extraction result”) that lists the extracted agents. Further, the second extraction portion 1202 refers to the field-of-expertise determination table 1820, extracts agents from the first extraction result in terms of expertise, and generates information listing the extracted agents (hereinafter referred to as the “second extraction result”).

The agent organization evaluation section 125 evaluates organizations (for example, law firms, judicial scrivener offices, administrative scrivener offices; hereinafter referred to as “agent organizations”), to which the agents listed in the second extraction result belong, based on the contents of the agent capability DB 180 and the agent information DB 185, generates information describing results of the evaluation (hereinafter referred to as “evaluation information”), and reflects the generated evaluation information in the request status table 1870. The agent organization evaluation section 125 evaluates the agent organization, based on, for example, the physical distance from the location of the client to the location of the agent organization (the closer the two are, the higher the evaluation because the convenience is higher), the fee paid to the agent organization (unit price, agency fee, other costs), the reputation of the agent organization, and the like. The evaluation information may be received from a user via a user interface, or the agent organization evaluation section 125 may generate the evaluation information, based on an evaluation using a predetermined algorithm or machine learning model. In a case where there are a plurality of agents in the same agent organization, the agent organization evaluation section 125 registers, for example, evaluation information of the agent with the highest evaluation in the request status table 1870 as the evaluation information of the agent organization.

The recommendation section 130 specifies the agent organization, to which the agent described in the second extraction result belongs, from the basic information table 1851, and transmits, to the client terminal 200, information including the second extraction result, the agent organization to which each agent belongs, and the evaluation information of each agent. The client terminal 200 receives the information from the recommendation section 130 and presents the received information to a user. The client terminal 200 also receives designation of an agent from the user and transmits information specifying the designated agent (hereinafter referred to as the “agent ID”) and information specifying the designated agent organization (hereinafter referred to as the “agent organization ID”) to the agency request support device 100. The recommendation section 130 receives the agent ID and agent organization ID sent from the client terminal 200.

In a case of receiving the agent ID from the client terminal 200, the agent request section 135 updates the request status table 1870. Further, the agent request section 135 transmits information, which is for requesting (entrusting) the agent to perform an agency service, (hereinafter referred to as an “agency request notification”) to the agent terminal 300 of the agent organization to which the agent corresponding to the agent ID received by the recommendation section 130 belongs. In a case of receiving the agency request notification, the agent terminal 300 presents information indicating that a request has been made by the client to the agent. In addition, the agency request notification may include, for example, information about the specific content of the requested service.

The reliability determination table generation section 140 performs processing related to generation (including editing and deletion) of the reliability determination table 1810. The details of this processing will be described later.

The field-of-expertise determination table generation section 145 has a field-specific experience value calculation portion 1451 and a field-of-expertise candidate generation portion 1452. The field-specific experience value calculation portion 1451 calculates an experience value of the agent for each field. The field-of-expertise candidate generation portion 1452 generates (including editing and deleting) the field-of-expertise determination table 1820 based on the experience value of the agent for each field.

The agent capability display section 150 transmits contents of the reliability determination table 1810 and the field-of-expertise determination table 1820 to the agent terminal 300. The agent terminal 300 receives the contents of the field-of-expertise determination table 1820 and presents the contents to the agent.

The request evaluation registration section 155 receives the client's evaluation of the agent sent from the client terminal 200, and reflects the received evaluation in the application history table 1852.

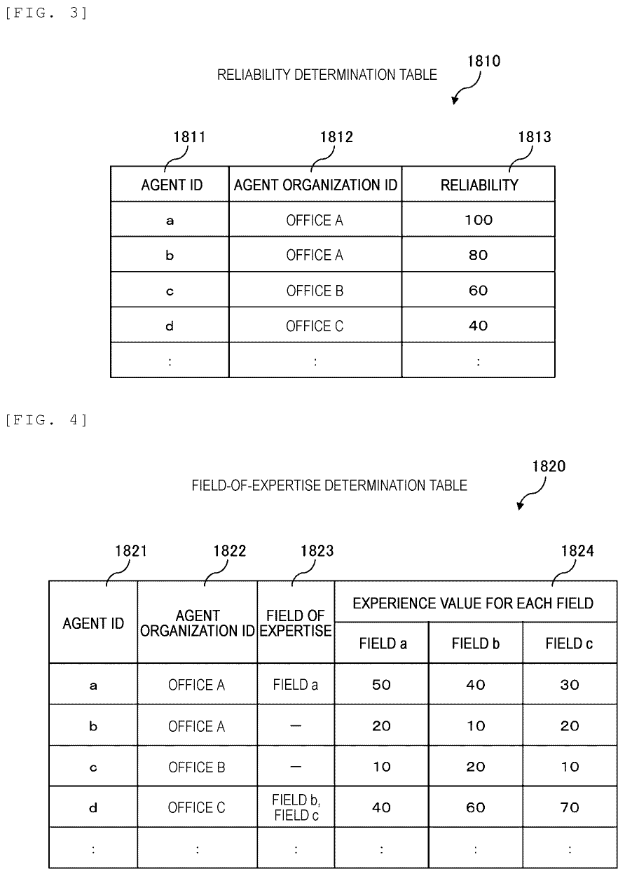

FIG. 3 illustrates an example of the reliability determination table 1810. In the reliability determination table 1810, the reliabilities of the agents are managed. The exemplary reliability determination table 1810 includes one or more records having the following items: agent ID 1811, agent organization ID 1812, and reliability 1813. One record in the reliability determination table 1810 corresponds to one agent.

Among the above-mentioned items, in the agent ID 1811, the agent IDs (names of the agents, and the like) are stored. In the agent organization ID 1812, the agent organization IDs (office names, and the like) of the organizations, to which the agents belong, are stored. In the reliability 1813, information indicating the reliability of the agents is stored. In the present example, each value indicating the reliability (maximum value is 100) is stored. The larger the value, the higher the reliability. A method of generating the reliability determination table 1810 will be described later in detail.

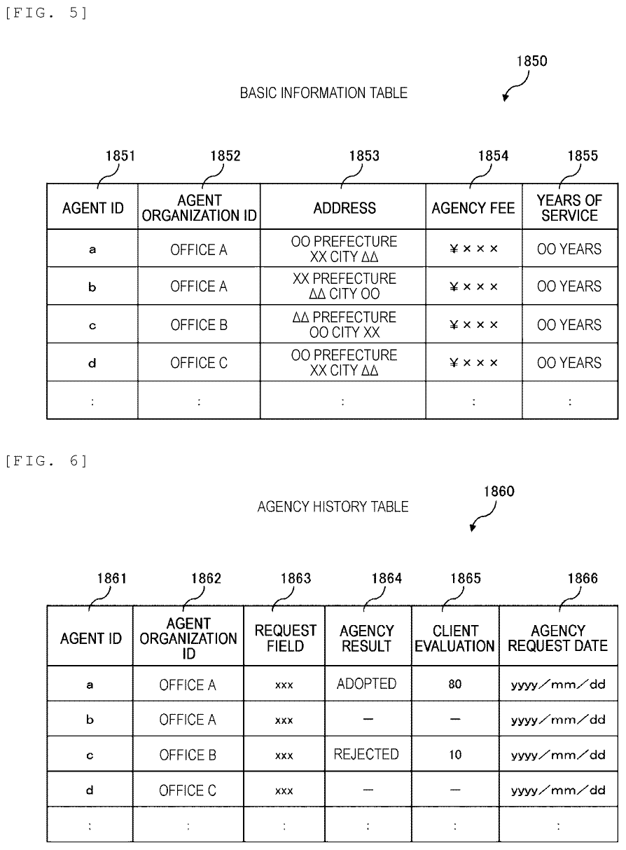

FIG. 4 illustrates an example of the field-of-expertise determination table 1820. In the field-of-expertise determination table 1820, information indicating the field of expertise and experience value of each agent (information indicating the expertise of each agent) is managed. The exemplary field-of-expertise determination table 1820 includes one or more records having the following items: agent ID 1821, agent organization ID 1822, field of expertise 1823, and experience value for each field 1824. One record in the field-of-expertise determination table 1820 corresponds to one agent.

In the agent ID 1821, among the above-mentioned items, the agent IDs are stored. In the agent organization ID 1822, the agent organization IDs of the organizations, to which the agents belong, are stored. In the field of expertise 1823, information indicating the fields of expertise of the agents is stored. In the experience value for each field 1824, information indicating the experience values of the agents for each field is stored. In the present example, each value indicating each experience value (maximum value is 100) is stored. The larger the value, the more experience (more expert, higher skill). A method of generating the field-of-expertise determination table 1820 will be described later in detail.

FIG. 5 illustrates an example of a basic information table 1850. In the basic information table 1850, basic information (hereinafter referred to as “basic information”) related to each agent is managed. The exemplary basic information table 1850 includes one or more records having the following items: agent ID 1851, agent organization ID 1852, address 1853, agency fee 1854, and years of service 1855. One record of the basic information table 1850 corresponds to one agent.

In the agent ID 1851, among the above-mentioned items, the agent IDs (names of the agents, and the like) are stored. In the agent organization ID 1852, the agent organization IDs (office names, and the like) of the organizations, to which the agents belong, are stored. In the address 1853, the addresses of the agent organizations are stored. In the agency fee 1854, fees (basic fee, additional fee, and the like) in a case where each agent is requested to perform an agency service are stored. In the years of service 1855, the numbers of years of service (the numbers of years of attendance) of the agent at the agent organization are stored.

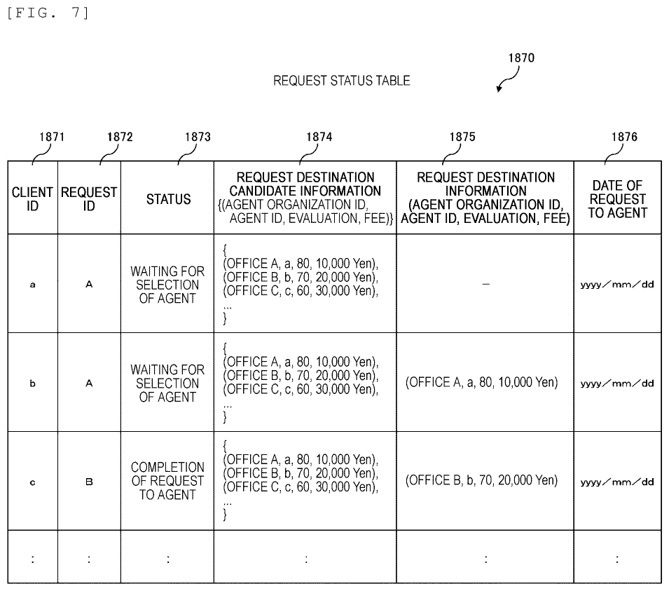

FIG. 6 illustrates an example of an agency history table 1860. In the agency history table 1860, the agency history of each agent is managed. The exemplary agency history table 1860 includes one or more records having the following items: agent ID 1861, agent organization ID 1862, request field 1863, agency result 1864, client evaluation 1865, and agency request date 1866. One record in the agency history table 1860 corresponds to one agency history of one agent.

In the agent ID 1861, among the above-mentioned items, the agent IDs (names of the agents, and the like) are stored. In the agent organization ID 1862, the agent organization IDs (office names, and the like) of the organizations, to which the agents belong, are stored. In the request field 1863, information indicating the fields of the agency requests is stored. In the agency result 1864, information indicating the result of each agent who performs an agency service in response to the agency request (for example, information such as whether the application documents were “accepted” or “not accepted” by the public institution) is stored. In the client evaluation 1865, the clients' evaluations for the agency requests handled by the agents are stored. In the present example, each value indicating each evaluation (maximum value is 100) is stored. The higher the value, the higher the evaluation. In the agency request date 1866, dates on which the agents accepted the agency requests are stored.

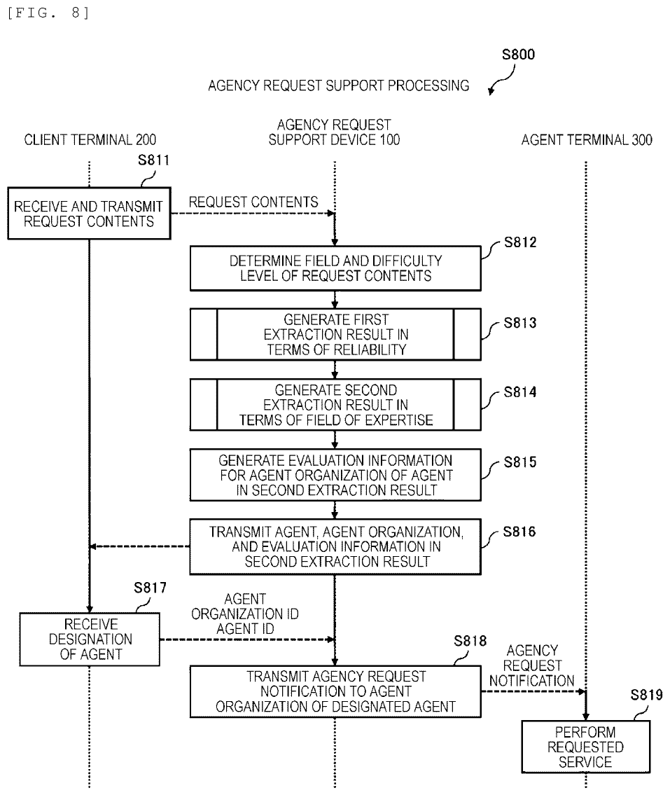

FIG. 7 illustrates an example of a request status table 1870. In the request status table 1870, agency requests that have been received from clients (agency requests that have not yet been processed by the agents after being received) are managed. The exemplary request status table 1870 includes one or more records having the following items: client ID 1871, request ID 1872, status 1873, request destination candidate information 1874, request destination information 1875, and date of request to agent 1876. One record in the request status table 1870 corresponds to one agency request received from a client.

In the client ID 1871, among the above-mentioned items, the clients' identifiers (such as the clients' names; hereafter referred to as the “client IDs”) are stored. In the request ID 1872, the identifiers of the received agency requests (hereafter referred to as the “request IDs”) are stored. In the status 1873, information indicating the current statuses of the agency requests (such as “waiting for agent selection” or “completion of the request to the agent”) is stored. In the request destination candidate information 1874, information about one or more candidate for request destination agents narrowed down for the agency requests (agent organization names, agent names, evaluation information of the agent organizations, fees, and the like) is stored. In the request destination information 1875, information about the agent selected for the agency request (agent organization names, agent names, evaluation information of the agent organizations, fees, and the like) is stored. In the date of request to agent 1876, dates on which the agents were requested to process the agency requests are stored.

Next, various kinds of processing performed in the matching support system 1 will be described in order.

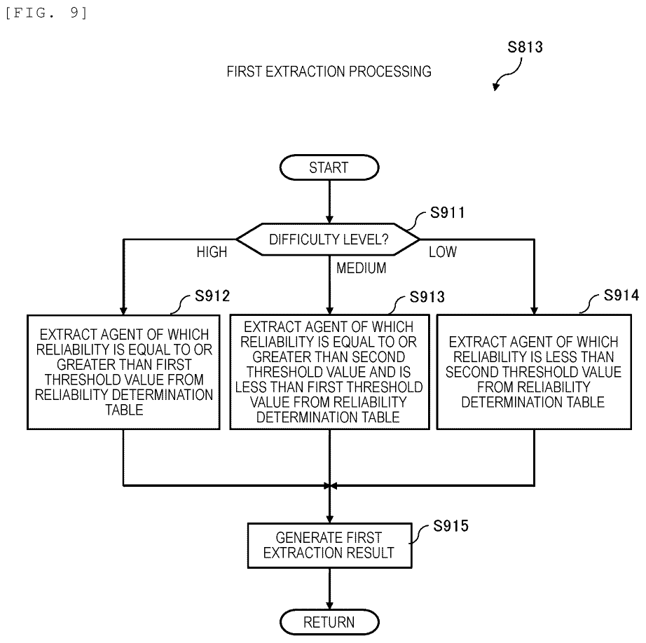

FIG. 8 is a flowchart illustrating the processing (hereinafter referred to as “agency request support processing S800”) performed in the matching support system 1. Hereinafter, the agency request support processing S800 will be described with reference to the drawing.

First, the client terminal 200 receives request information from a user via a user interface and transmits the received request information to the agency request support device 100. The request information receiving section 110 of the agency request support device 100 receives the request information sent from the client terminal 200 (S811).

Next, the request field determination portion 1151 determines the request field of the request received from the user based on the request information, and the difficulty level determination portion 1152 determines the difficulty level of the request received from the user based on the request information (S812).

Subsequently, the first extraction portion 1201 extracts agents to be recommended as candidates from the basic information table 1851 based on the reliability determination table 1810 to generate a first extraction result (S813).

FIG. 9 is a flowchart illustrating the processing performed by the first extraction portion 1201 in S813 in FIG. 8 (hereinafter referred to as “first extraction processing S813”). Hereinafter, the first extraction processing S813 will be described with reference to the drawing.

As illustrated in FIG. 9, first, the first extraction portion 1201 bifurcates the subsequent processing according to the difficulty level determined in S812 (S911).

In a case where the difficulty level determined in S812 is “high” (S911: high), the first extraction portion 1201 extracts agents, each of which has the reliability 1813 equal to or greater than a first threshold value which is set in advance, from the reliability determination table 1810 (S912), and generates the first extraction result including a list of the extracted agents (S915). Thereafter, the processing proceeds to S814 in FIG. 8.

Further, in a case where the difficulty level determined in S812 is “medium” (S911: medium), the first extraction portion 1201 extracts agents, each of which has the reliability 1813 equal to or greater than a second threshold value which is set in advance and less than the first threshold value, from the reliability determination table 1810 (S913), and generates the first extraction result including the list of the extracted agents (S915). Thereafter, the processing proceeds to S814 in FIG. 8.

Further, in a case where the difficulty level determined in S812 is “low” (S911: low), the first extraction portion 1201 extracts agents, each of which has the reliability 1813 less than the second threshold value which is set in advance, from the reliability determination table 1810 (S914), and generates the first extraction result including the list of the extracted agents (S915). Thereafter, the processing proceeds to S814 in FIG. 8.

In such a manner, in the first extraction processing S813, an agent with a reliability corresponding to the difficulty level of the requested service is extracted as the first extraction result. For example, for a service with a high level of difficulty level, an agent with a high level of reliability is extracted, for a service with a medium level of difficulty level, an agent with a medium level of reliability is extracted, and for a service with a low level of difficulty level, an agent with a low level of reliability is extracted.

Returning to FIG. 8, the second extraction portion 1202 of the agent extraction section 120 then extracts the agents from the first extraction result based on the field-of-expertise determination table 1820 to generate the second extraction result (S814).

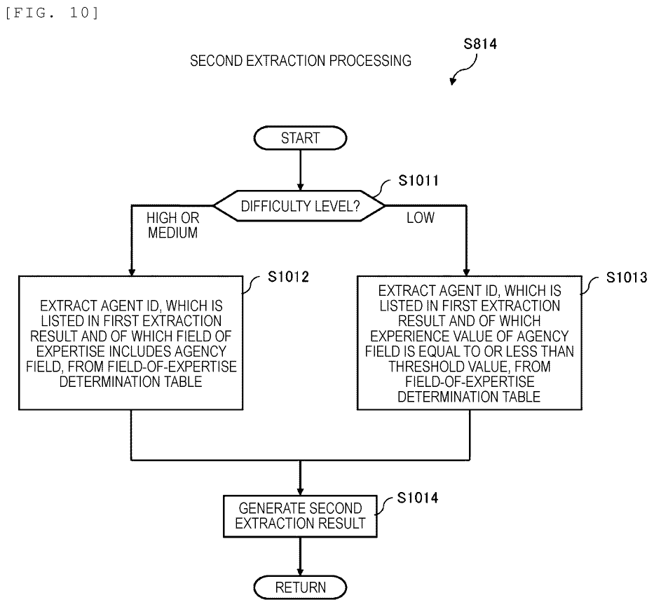

FIG. 10 is a flowchart illustrating processing performed by the second extraction portion 1202 in S814 in FIG. 8 (hereinafter referred to as “second extraction processing S814”). Hereinafter, the second extraction processing S814 will be described with reference to the drawing.

First, the second extraction portion 1202 bifurcates the subsequent processing depending on the difficulty level determined in S812 (S1011).

In a case where the difficulty level determined in S812 is “high” or “medium” (S1011: high or medium), the second extraction portion 1202 extracts agents, who are listed in the first extraction result and of which the field of expertise 1823 include the request field, from the field-of-expertise determination table 1820 to generate a second extraction result (S1012, S1014). Thereafter, the processing proceeds to S815 in FIG. 8.

Further, in a case where the difficulty level determined in S812 is “low” (S1011: low), the second extraction portion 1202 extracts agents, who are listed in the first extraction result and of which the experience values in the request field are equal to or less than a preset threshold value, from the field-of-expertise determination table 1820 to generate the second extraction result (S1013, S1014). Thereafter, the processing proceeds to S815 in FIG. 8.

In such a manner, in the second extraction processing S814, for a service with a difficulty level of “high” or “medium”, an agent, of which the field of expertise includes the request field, is extracted from among agents which are extracted as the first extraction result and of which the reliabilities are “high” or “medium”. Further, for a service with a difficulty level of “low”, an agent with little experience in the request field of the service is extracted from among agents which are extracted as the first extraction result and of which the reliabilities are “low”.

Returning to FIG. 8, the agent organization evaluation section 125 then specifies the agent organization, to which the agent in the second extraction result belongs, from the basic information table 1851, and generates evaluation information for the specified agent organization based on the contents of the agent capability DB 180 and the agent information DB 185. The agent organization evaluation section 125 also reflects the evaluation information in the request status table 1870 (S815).

Subsequently, the recommendation section 130 transmits, to the client terminal 200, recommendation information including the second extraction result, the specified agent organization, and evaluation information of each agent organization. Further, the recommendation section 130 updates a status 1873 of the request status table 1870 (S816).

The client terminal 200 receives the recommendation information transmitted from the recommendation section 130 and presents the received recommendation information to the user. Further, the client terminal 200 receives the designation of an agent organization or an agent from the user, and transmits the received agent ID and agent organization ID to the agency request support device 100. The recommendation section 130 receives the agent ID and agent organization ID transmitted from the client terminal 200 (S817).

The agent request section 135 transmits an agency request notification to the agent terminal 300 of the agent organization having the agent organization ID received by the recommendation section 130. Further, the agent request section 135 updates the status 1873 of the request status table 1870 (S818).

In a case of receiving the agency request notification, the agent terminal 300 presents, to the agent, that an agency request has been made. The agent performs the service designated in the agency request notification (S819).

As described above, according to the agency request support processing S800, for a service with a difficulty level of “high” or “medium”, an agent with high reliability and familiarity with the request field (high expertise) is extracted. Therefore, for a service with a “high” or “medium” level of difficulty level, it is possible to recommend, to the client, an agent organization or an agent that meets the needs of a client who wants to receive highly reliable service from the agent familiar with the request field. Further, the agent is likely to receive a request in the agent's field of expertise, and is able to provide high-quality services by utilizing the agent's expertise. Furthermore, as a result, the satisfaction of the client increases, and the agent can expect a satisfactory return.

Further, for a service with a “low” level of difficulty level, an agent with little experience is extracted from agents with low reliability. Therefore, for a service with a “low” level of difficulty level, it is possible to recommend an agent that meets the needs of the client who wants to enjoy a service quickly at a reasonable price (in the sense that the client is able to search widely for agents who can afford the load and thus increase the likelihood of providing the service quickly). Further, agent organizations and agents can expect benefits such as effective use of human resources (improvement of business efficiency) and the ability to advance the careers of inexperienced people (educational effect).

### Generation of Reliability Determination Table

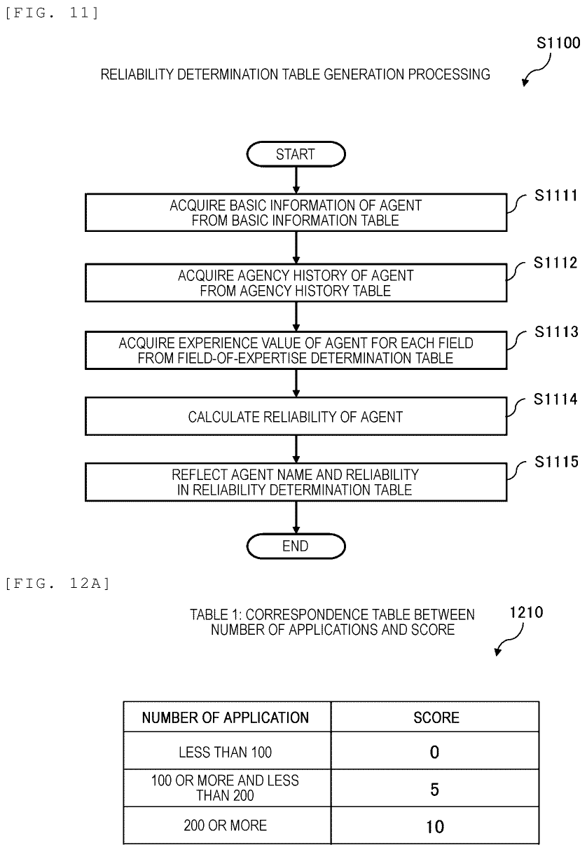

FIG. 11 is a flowchart illustrating processing (hereinafter referred to as “reliability determination table generation processing S1100”) which is performed by the reliability determination table generation section 140 of the agency request support device 100 in a case of generating the reliability determination table 1810. Hereinafter, the reliability determination table generation processing S1100 will be described with reference to the drawing. It should be noted that the reliability determination table generation processing S1100 described below is performed for each agent (agent ID 1851) in the basic information table 1850.

First, the reliability determination table generation section 140 acquires basic information about an agent subjected to the processing (hereinafter referred to as “the pertinent agent”) from the basic information table 1850 (S1111).

Subsequently, the reliability determination table generation section 140 acquires record information of the pertinent agent (agency history of the pertinent agent) from the agency history table 1860 (S1112).

Then, the reliability determination table generation section 140 acquires an experience value of the pertinent agent for each field from the field-of-expertise determination table 1820 (S1113).

Then, the reliability determination table generation section 140 calculates a reliability of the pertinent agent (S1114). The reliability determination table generation section 140 calculates the reliability based on, for example, the following expression (hereinafter referred to as “Expression 1”).

$$Reliability = average value of experience value of agent for each field in field - of - expertise determination table + score based on number + score based on adoption rate ( = number of adoptions / number of applications to current time ) \qquad [ Expression 1 ]$$

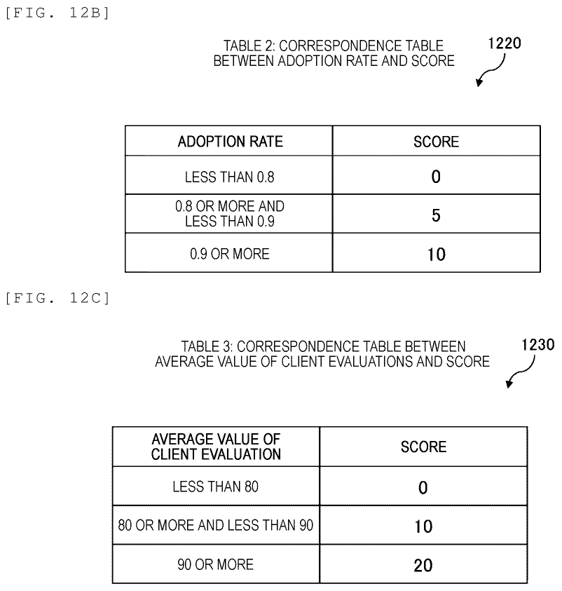

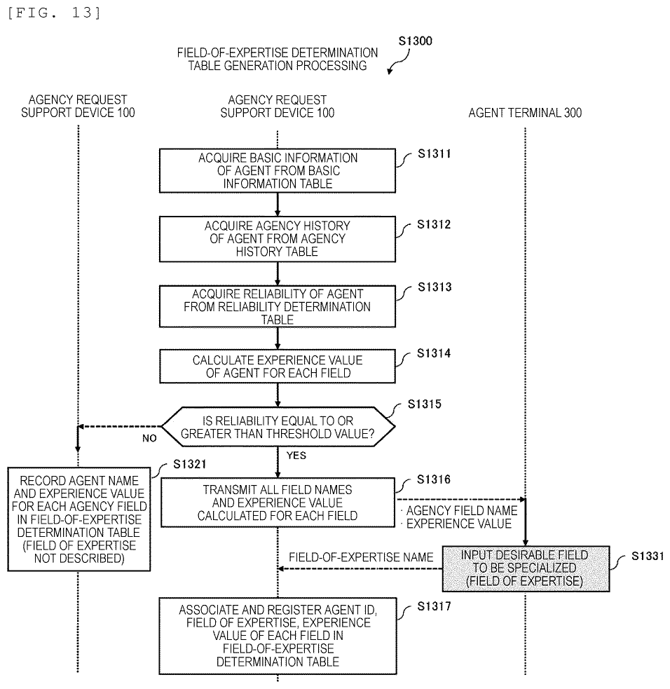

The reliability determination table generation section 140 calculates a second term “score based on number of applications” in Expression 1, for example, based on Table 1 illustrated in FIG. 12A (hereinafter referred to as a “correspondence table 1210 between numbers of applications and scores”). Further, the reliability determination table generation section 140 calculates a third term “score based on adoption rate (=number of adoptions/number of applications to current time)” in Expression 1, for example, based on Table 2 illustrated in FIG. 12B (hereinafter referred to as a “correspondence table 1220 between adoption rates and scores”).

Then, the reliability determination table generation section 140 generates a record, and stores (registers) the record in the reliability determination table 1810 (S1115). In the record, the agent ID of the pertinent agent, the agent organization ID of the organization to which the pertinent agent belongs, and the reliability calculated in S1214 are associated.

### Generation of Field-of-Expertise Determination Table

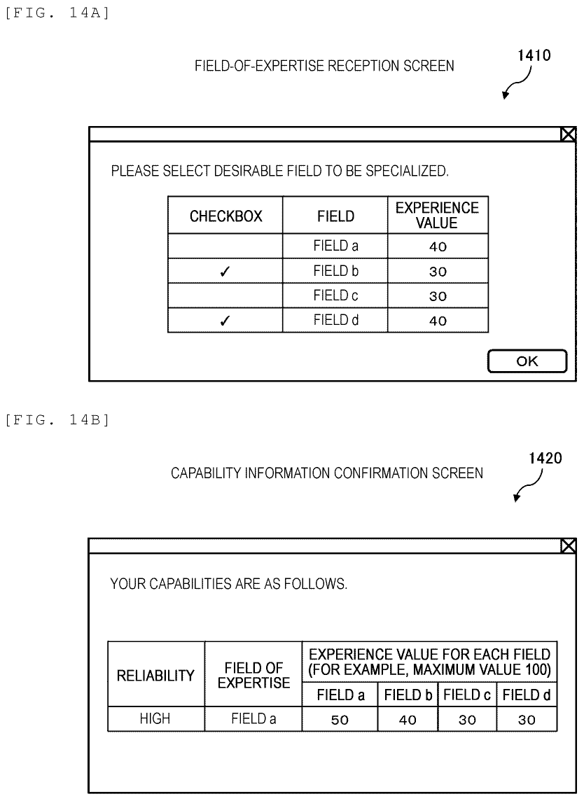

FIG. 13 is a flowchart illustrating processing (hereinafter referred to as “field-of-expertise determination table generation processing S1300”) which is performed by the field-of-expertise determination table generation section 145 of the agency request support device 100 in a case of generating the field-of-expertise determination table 1820. Hereinafter, the field-of-expertise determination table generation processing S1300 will be described with reference to the drawing. It should be noted that the field-of-expertise determination table generation processing S1300 is performed for each agent (agent ID 1851) in the basic information table 1850.

First, the field-of-expertise determination table generation section 145 acquires basic information about the agent subjected to the processing (hereinafter referred to as the “pertinent agent”) from the basic information table 1850 (S1311).

Then, the reliability determination table generation section 140 acquires record information of the pertinent agent (agency history of the pertinent agent) from the agency history table 1860 (S1312).

Then, the reliability determination table generation section 140 acquires a reliability of the pertinent agent from the reliability determination table 1810 (S1313).

Then, the reliability determination table generation section 140 calculates an experience value of the pertinent agent for each field (S1314). The field-of-expertise determination table generation section 145 calculates the experience value for each field based on, for example, the following expression (hereinafter referred to as “Expression 2”).

$$Experience value in XX field = score based on number of applications in XX field of agent in application history table + score based on adoption rate of XX field ( = number of adoptions / number of applications to current time ) + score based on average value of client evaluations in XX field \qquad [ Expression 2 ]$$

The field-of-expertise determination table generation section 145 calculates a first term “score based on number of applications in XX field of agent in application history table” in Expression 2, for example, based on Table 1 illustrated in FIG. 12A (correspondence table 1210 between numbers of applications and scores). Further, the field-of-expertise determination table generation section 145 calculates a second term “adoption rate in XX field (=number of adoptions/number of applications to current time)” in Expression 2, for example, based on Table 2 illustrated in FIG. 12B (correspondence table 1220 between adoption rates and scores). Furthermore, the field-of-expertise determination table generation section 145 calculates a third term “score based on average values of client evaluations in XX field” in Expression 2, for example, based on Table 3 illustrated in FIG. 12C (hereinafter referred to as a “correspondence table 1230 between average values of client evaluations and scores”).

Subsequently, the field-of-expertise determination table generation section 145 determines whether the reliability acquired in S1313 is equal to or greater than a preset threshold value (S1315).

In a case where the reliability is equal to or greater than the preset threshold value (S1315: YES), the field-of-expertise determination table generation section 145 transmits all field names and the experience value calculated for each field to the agent terminal 300 (S1316). The agent terminal 300 receives an input of a desirable field to be specialized (field of expertise) from the agent while presenting all the field names and the experience value calculated for each field sent from the agency request support device 100, and transmits the received field to the agency request support device 100 (S1331). In a case of receiving the field from the agent terminal 300, the field-of-expertise determination table generation section 145 generates a record in the field-of-expertise determination table, and stores (registers) the record in the field-of-expertise determination table 1820 (S1317). In the record, the agent ID of the pertinent agent, the agent organization ID of the organization to which the pertinent agent belongs, the field received from the agent terminal 300, and the experience value of each field calculated in S1314 are associated.

In S1315, in a case where the reliability is less than the preset threshold value (S1315: NO), the field-of-expertise determination table generation section 145 generates a record in the field-of-expertise determination table, and stores (registers) the record in the field-of-expertise determination table 1820 (S1321). In the record, the agent ID of the pertinent agent, the agent organization ID of the organization to which the pertinent agent belongs, and the experience values in each field calculated in S1314 are associated (in such a case, the item of the field of expertise 1823 is not described).

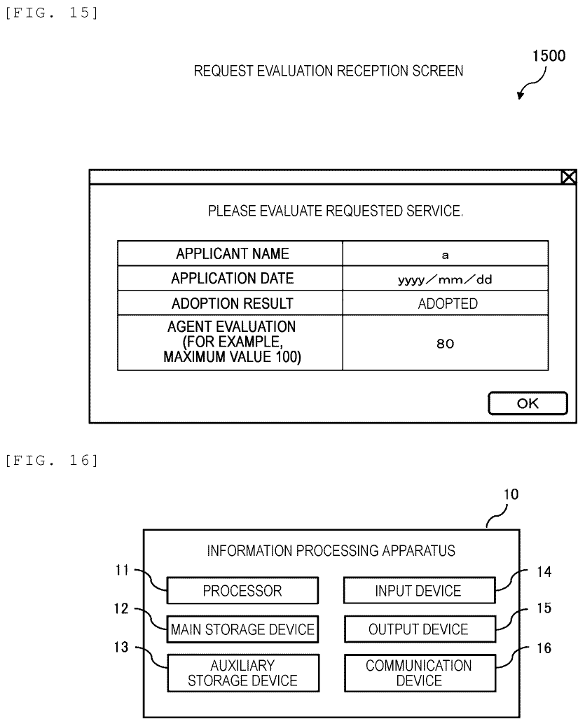

FIGS. 14A and 14B each illustrate an example of a screen (hereinafter referred to as a “field-of-expertise reception screen 1410”) displayed in a case where the agent terminal 300 receives a field (field of expertise) from the agent in S1331.

### Processing of Agent Capability Display Section

The agent capability display section 150 of the agency request support device 100 generates a screen (hereinafter referred to as a “capability information confirmation screen 1420”), which describes the agent's capability (reliability, field of expertise, and experience value for each field), based on the information managed by the agent capability DB 180 (the reliability determination table 1810 and the field-of-expertise determination table 1820), and presents the screen to a user.

FIG. 14B illustrates an example of the capability information confirmation screen 1420. In addition, the agent capability display section 150 may transmit the capability information confirmation screen 1420 to the agent terminal 300, such that the agent is able to refer to the capability information confirmation screen 1420. The agent is able to confirm what content of the agent's capability is registered in the agency request support device 100 by referring to the capability information confirmation screen 1420.

### Request Evaluation Registration Section

The request evaluation registration section 155 of the agency request support device 100 receives an evaluation of the service performed by the agent from the client via the client terminal 200, and reflects the received evaluation in the agency history table 1860.

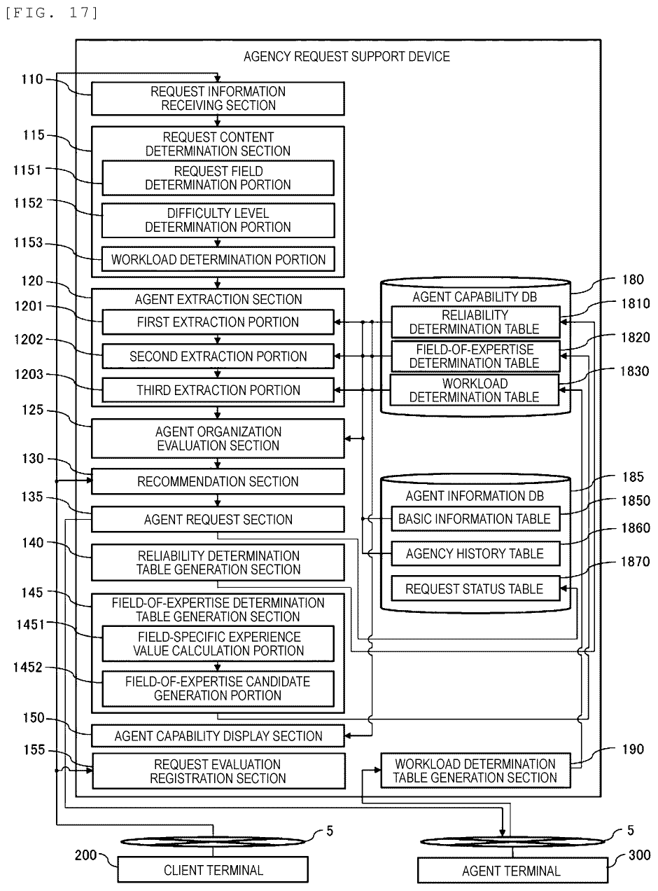

FIG. 15 illustrates an example of a screen (hereinafter referred to as a “request evaluation reception screen 1500”) displayed by the client terminal 200 in a case of receiving an evaluation from the client.

### Example of Information Processing Apparatus

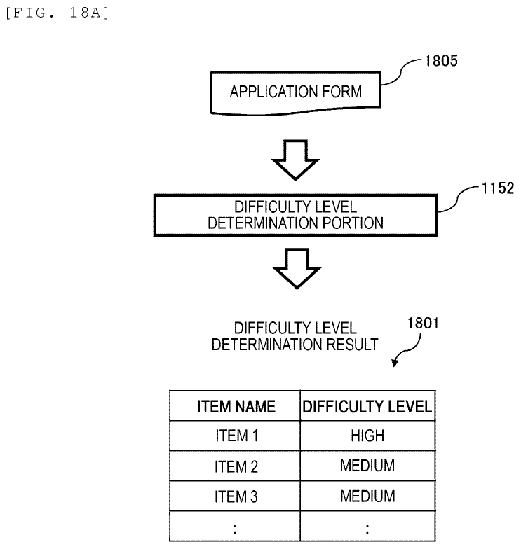

FIG. 16 is an example of a hardware configuration of an information processing apparatus (computer) used in the configuration of the matching support system 1 (implemented by the agency request support device 100, the client terminal 200, and the agent terminal 300).

The exemplary information processing apparatus 10 includes a processor 11, a main storage device 12 (memory), an auxiliary storage device 13 (external storage device), an input device 14, an output device 15, and a communication device 16. These are connected to one another so as to be able to communicate with one another via a bus or a communication cable. Examples of the information processing apparatus 10 include a personal computer, a server device, a smartphone, a tablet, an office computer, a general-purpose machine (mainframe), and the like.

The information processing apparatus 10 may be implemented entirely or partially using virtual information processing resources that are provided using a virtualization technique, a processing space separation technique, and the like, such as a virtual server provided by a cloud system. Further, all or a part of the functions provided by the information processing apparatus 10 may be implemented by a service provided by a cloud system via an application programming interface (API), and the like. Furthermore, all or a part of the functions provided by the information processing apparatus 10 may be implemented using, for example, software as a service (Saas), platform as a service (PaaS), infrastructure as a service (IaaS), and the like.

The processor 11 is configured using, for example, a central processing unit (CPU), a micro processing unit (MPU), a graphics processing unit (GPU), a field programmable gate array (FPGA), an application specific integrated circuit (ASIC), an artificial intelligence (AI) chip, and the like.

The main storage device 12 is a device used by the processor 11 in a case of executing a program, and is, for example, a read only memory (ROM), a random access memory (RAM), a non-volatile memory (Non Volatile RAM; NVRAM), or the like. Various functions implemented in the agency request support device 100, the client terminal 200, and the agent terminal 300 are implemented by the respective processors 11 reading and executing the programs and data stored (memorized) in the auxiliary storage device 13 into the main storage device 12.

The auxiliary storage device 13 is a device that stores programs and data, and can be configured, for example, in a solid state drive (SSD), a hard disk drive, optical storage devices (such as a compact disc; CD and a digital versatile disc; DVD), a storage system, a read/write device for non-transitory recording media such as an IC card, an SD card, and an optical recording medium, or a non-transitory storage region of a cloud server. Programs and data can be read into the auxiliary storage device 13 from other information processing apparatuses including non-transitory recording media or non-transitory storage devices, via a recording medium reading device or communication device 16. The programs and data stored (memorized) in the auxiliary storage device 13 are read into the main storage device 12 as necessary.

The input device 14 is an interface that receives an input of information from the outside, and is, for example, a keyboard, a mouse, a touch panel, a card reader, a tablet with a pen input method, a voice input device, or the like.

The output device 15 is an interface that outputs various kinds of information such as the processing progress and the processing result to the outside. Examples of the output device 15 include display devices (a liquid crystal monitor, a liquid crystal display (LCD), and a graphic card) that visualize the various kinds of information, a device (voice output device (such as a speaker)) that converts the various kinds of information into voice, and a device (such as a printer) that converts the various kinds of information into text. It should be noted that, for example, the information processing apparatus 10 may be configured to input and output information to and from other devices via the communication device 16.

The input device 14 and the output device 15 are configured to be included in a user interface that implements interactive processing (receiving information, providing information, and the like) with a user.

The communication device is a device that implements communication with other devices. The communication device 16 is a wired or wireless communication interface that implements communication with other devices via a communication network, such as a network interface card (NIC), a wireless communication module, or a USB module.

In addition, the information processing apparatus 10 may employ, for example, an operating system, a file system, a database management system (DBMS such as relational database or NoSQL), a key-value store (KVS), and the like.

### Second Embodiment

In the matching support system 1 according to the first embodiment, the agents to be recommended to the clients are extracted in terms of reliability and field (field of expertise). In a matching support system 1 according to a second embodiment, agents are extracted in consideration of the workload required to perform the service. Further, the matching support system 1 according to the second embodiment extracts agents in consideration of the case where a plurality of agents jointly perform a service for one request. In such a manner, the matching support system 1 according to the second embodiment extracts agents to be recommended in consideration of the workload. Therefore, it is possible to reduce the possibility of an agent that cannot handle the workload being recommended and the request from the client being rejected by the agent.

The matching support system 1 according to the second embodiment calculates a workload required to perform the service related to the agency request for each difficulty level from the request information of the agency request received from the client. Then, the matching support system 1 extracts an agent by comparing a workload for each difficulty level with a workload that each agent of each agent organization, which is stored separately, can handle.

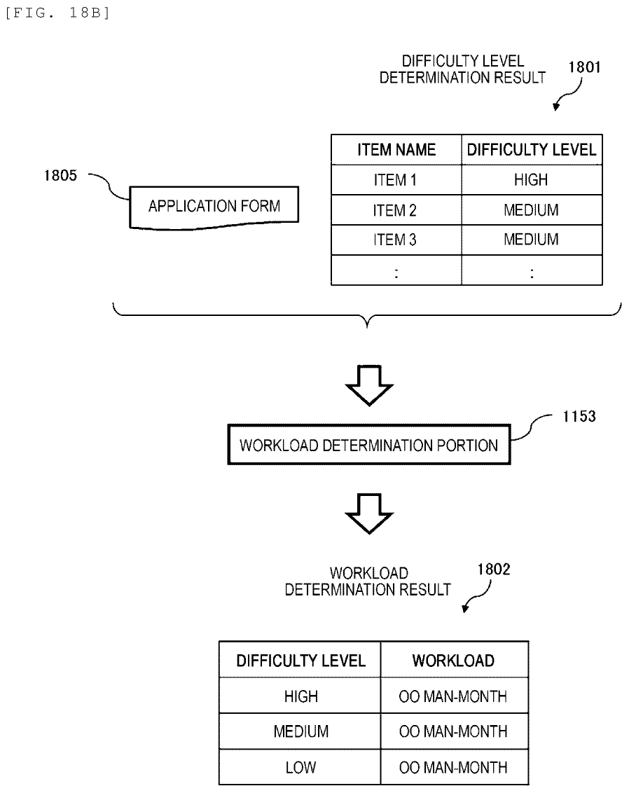

FIG. 17 is a diagram illustrating main functions of an agency request support device 100 of the matching support system 1 according to the second embodiment. The agency request support device 100 according to the second embodiment has the same basic configuration as the agency request support device 100 according to the first embodiment, but has a configuration different from that of the agency request support device 100 according to the first embodiment in the following points.

First, processing of the difficulty level determination portion 1152 of the request content determination section 115 is different. Further, the configuration is different in that the request content determination section 115 further includes a workload determination portion 1153. The configuration is also different in that the first extraction portion 1201 and the second extraction portion 1202 perform processing for each difficulty level of the request information. The configuration is also different in that the agent extraction section 120 further includes a third extraction portion 1203. The configuration is also different in that the agent capability DB 180 manages a workload determination table 1830 used to determine the workload of the service. The configuration is also different in that the agent request section 135 subtracts, for each requested agent, the time corresponding to the workload required for the received work from the available work time of the record of the pertinent agent in the workload determination table 1830. The configuration is also different in that a workload determination table generation section 190 is further provided. Hereinafter, a description will be given focusing on the differences from the agency request support device 100 according to the first embodiment.

The difficulty level determination portion 1152 of the agency request support device 100 according to the second embodiment determines the difficulty level for each element of the service (for example, for each item of the application form). The difficulty level determination portion 1152 generates and manages (stores) a difficulty level determination result that describes the result of the determination. It should be noted that a user may determine the difficulty level or the difficulty level determination portion 1152 may automatically determine the difficulty level based on the request information. For example, the difficulty level is determined based on the adoption rate of past applications (the lower the adoption rate, the higher the difficulty level), the amount of writing in the application form (the more writing, the higher the difficulty level), and the amount of free description (the more free description, the higher the difficulty level).

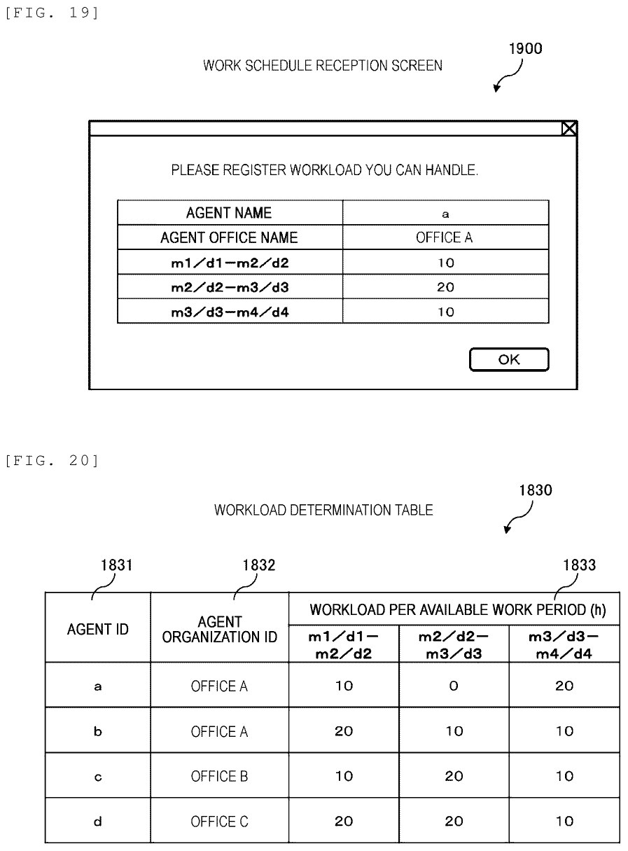

FIG. 18A illustrates a situation where the difficulty level determination portion 1152 determines the difficulty level for each element (each item) based on contents of an application form 1805 included in the request information and generates a difficulty level determination result 1801.

Returning to FIG. 17, the workload determination portion 1153 of the agency request support device 100 determines (estimates) the workload required to perform the service for the received request based on the request information. The workload determination portion 1153 determines the workload of the requested service for each difficulty level determined for each element. The workload determination portion 1153 generates and manages (stores) a workload determination result that describes the result of the determination.

FIG. 18B illustrates a situation where the workload determination portion 1153 determines the workload of the requested service for each difficulty level determined for each element and generates the workload determination result 1802.

Returning to FIG. 17, the third extraction portion 1203 refers to the workload determination table 1830, extracts a combination of agents capable of performing the requested work from the second extraction result, and generates a third extraction result describing the extraction result.

The workload determination table generation section 190 of the agency request support device 100 according to the second embodiment receives a work schedule (already scheduled work date time/work period and workload) from the agent via the agent terminal 300, and generates (including editing, deleting, and the like) the workload determination table 1830 based on the received work schedule.

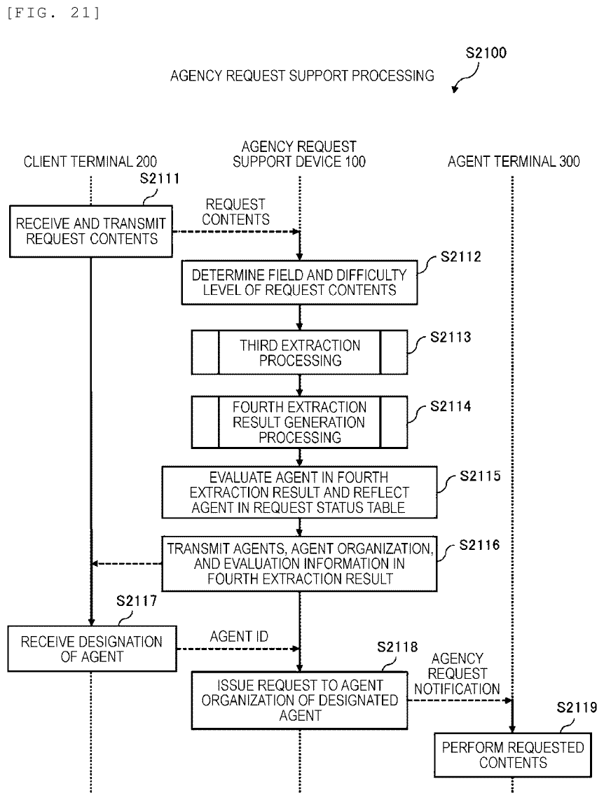

FIG. 19 is an example of a screen (hereinafter referred to as a “work schedule reception screen 1900”) displayed by the workload determination table generation section 190 in a case where the agent terminal 300 receives the work schedule from the agent. The work schedule reception screen 1900 may be generated by the agent terminal 300, or may be generated by the agency request support device 100 and transmitted to the agent terminal 300.

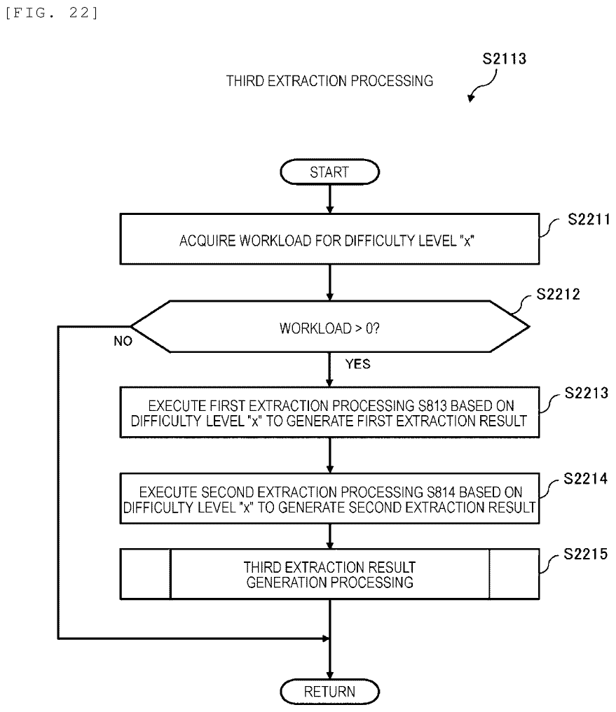

FIG. 20 illustrates an example of the workload determination table 1830 generated by the workload determination table generation section 190 based on the received work schedule. As illustrated in the drawing, the workload determination table 1830 includes one or more records having the items including agent ID 1831, agent organization ID 1832, and workload per available work period 1833. One record in the workload determination table 1830 corresponds to one agent.

In the agent ID 1831, among the above-mentioned items, the agent IDs of the pertinent agents are stored. In the agent organization ID 1832, the agent organization IDs of the organizations to which the pertinent agents belong, are stored. In the workload per available work period 1833, the workload (in hours (h)) for each available work period is stored.

FIG. 21 is a flowchart illustrating processing (hereinafter referred to as “agency request support processing S2100”) performed in the matching support system 1 according to the second embodiment. The processing of S2111 of the agency request support processing S2100 is the same as S811 of the agency request support processing S800 illustrated in FIGS. 8, and S2117 to S2119 are the same as S817 to S819 of the agency request support processing S800 illustrated in FIG. 8. However, the processing of S2112 to S2116 are different from that of the agency request support processing S800 illustrated in FIG. 8. Hereinafter, the agency request support processing S2100 according to the second embodiment will be described with reference to the drawing, focusing on the differences from the agency request support processing S800.

In S2112, the request field determination portion 1151 determines the field of the requested service (such as the type of application form), and the difficulty level determination portion 1152 determines the difficulty level for each element of the service (for example, each item of the application form) using the method described above. The agency request support device 100 stores the determined field and the difficulty level for each element as the difficulty level determination result 1801 (S812).

In S2113, the agent extraction section 120 (the first extraction portion 1201 and the second extraction portion 1202) performs processing for each difficulty level of the difficulty level determination result 1801, and performs processing of generating the first extraction result and the second extraction result (hereinafter referred to as the “third extraction processing S2113”).

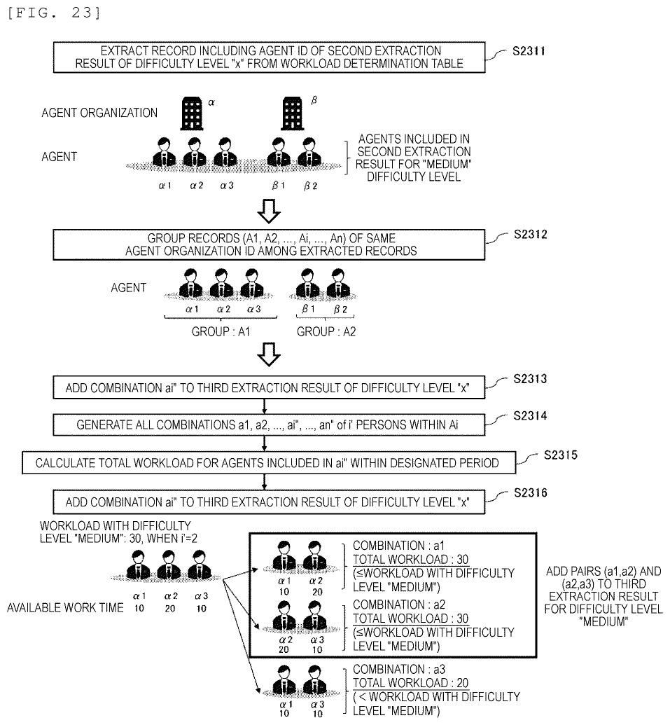

FIG. 22 is a flowchart illustrating the third extraction processing S2113. Hereinafter, the third extraction processing S2113 will be described with reference to the drawing. It should be noted that the drawing corresponds to processing for a certain difficulty level “x”. That is, the third extraction processing S2113 is executed for each difficulty level.

As illustrated in the drawing, first, the agent extraction section 120 acquires the workload for the difficulty level “x” determined by the difficulty level determination portion 1152 (S2211).

Then, the agent extraction section 120 determines whether the acquired workload is greater than “0” (S2212). In a case where the workload is not greater than “0” (S2212: NO), the third extraction processing S2113 for the difficulty level ends. In a case where the workload is greater than “0” (S2212: YES), the processing proceeds to S2213.

In S2213, the first extraction portion 1201 sets the difficulty level to “x” and executes the first extraction processing S813 illustrated in FIG. 9, thereby generating a first extraction result.

Then, the second extraction portion 1202 performs the second extraction processing S814 illustrated in FIG. 10 with the difficulty level set to “x”, thereby generating a second extraction result (S2214).

Then, the third extraction portion 1203 performs processing of extracting agents based on the second extraction result in consideration of the workload and generating a third extraction result that describes the extraction result (hereinafter referred to as “third extraction result generation processing S2215”).

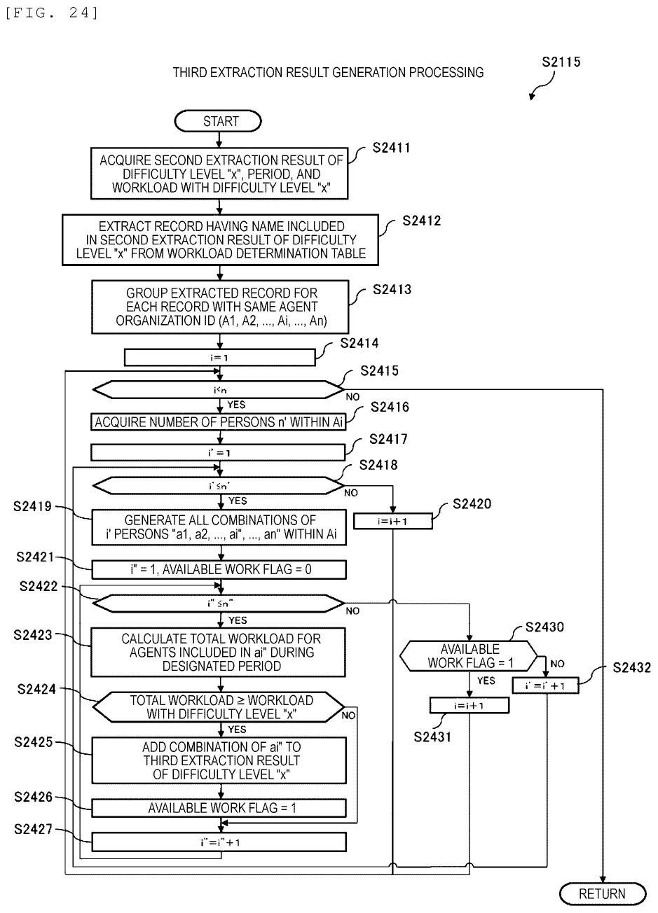

FIG. 23 is a diagram illustrating a brief overview of the third extraction result generation processing S2215. Hereinafter, a brief overview of the third extraction result generation processing S2215 will be described together with the drawing.

First, the third extraction portion 1203 extracts the record including agent IDs of the second extraction result of difficulty level “x” from the workload determination table 1830 (S2311). In the example illustrated in the drawing, records of three agents α1 to α3 are extracted from an agent organization α, and records of two agents β1 to β2 are extracted from an agent organization β.

Then, the third extraction portion 1203 groups the records of agents belonging to the same agent organization (having the same agent organization ID) (S2312). In the example illustrated in the drawing, the records of the agents α1 to α3 are grouped into a group A1, and the records of the agents β1 to β2 are grouped into a group A2.

Then, the third extraction portion 1203 adds the record of the combination ai″ to the third extraction result of difficulty level “x” (S2313). It should be noted that i″ represents what number the sequence is in the combinations a of small groups consisting of i′ persons, in a case where i′ is the number of persons in a small group created in group Ai.

Then, the third extraction portion 1203 generates all combinations a1, a2, . . . , ai″, . . . , an″ of i′ persons within Ai (S2314). It should be noted that n is the total number of groups A for each agent organization. In addition, n″ is the total number of combinations a.

Then, the third extraction portion 1203 calculates the total workload for the agents included in ai″ within the designated period (S2315).

Then, the third extraction portion 1203 stores the combination ai″ in the third extraction result of difficulty level “x” (S2316).

The drawing illustrates an example in which the difficulty level of the requested service is “medium”, the workload is “30”, i′ is “2”, the available work time of agent α1 is “10”, the available work time of agent α2 is “20”, and the available work time of agent α3 is “10”. In such a case, for the combination “a1” and combination “a2” illustrated in the thick line frame in the drawing, the total available work time of the agents is equal to or less than the workload “30”, and the work can be performed. Therefore, the third extraction portion 1203 stores records corresponding to respective combinations of (α1, α2) and (α2, α3) in the third extraction result of difficulty level “medium”.

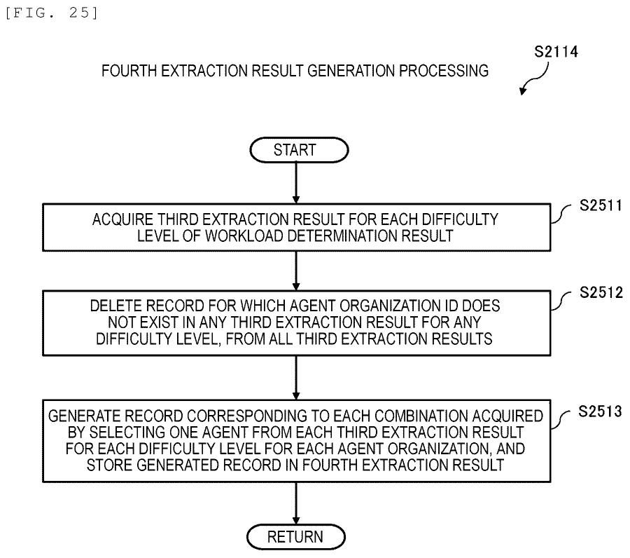

FIG. 24 is a flowchart illustrating the third extraction result generation processing S2215. Hereinafter, the third extraction result generation processing S2215 will be described with reference to the drawing.

First, the third extraction portion 1203 acquires the second extraction result of difficulty level “x”, the period, and the workload for the difficulty level “x” (S2411).

Then, the third extraction portion 1203 extracts a record, in which the second extraction result of difficulty level “x” includes an agent ID, from the workload determination table (S2412).

Subsequently, the third extraction portion 1203 groups the extracted record (generates A1, A2, . . . , Ai, . . . , An) for each of the records with the same agent organization ID (S2413).

Then, the third extraction portion 1203 sets the index i to “1” (S2414).

Then, the third extraction portion 1203 determines whether i is equal to or less than n (S2415). In a case where i is equal to or less than n (S2415: YES), the processing proceeds to S2416. On the other hand, in a case where i is greater than n (S2415: NO), the third extraction result generation processing S2215 ends.

Then, the third extraction portion 1203 acquires the number of persons n′ in Ai (total number in Ai) (S2416).

Subsequently, the third extraction portion 1203 sets i′ to “1” (S2417).

Then, the third extraction portion 1203 determines whether i′ is equal to or less than n (S2418). In a case where i′ is equal to or less than n (S2418: YES), the processing proceeds to S2419. On the other hand, in a case where i′ is greater than n (S2418: NO), i is incremented by “1”, and the processing returns to S2415.

In S2419, the third extraction portion 1203 generates all combinations of i′ persons within Ai: “a1, a2, . . . , ai″, . . . , an″”.

Then, the third extraction portion 1203 sets i″ to “1” and sets an available work flag to “0” (S2421).

Then, the third extraction portion 1203 determines whether i″ is equal to or less than n″ (S2418). In a case where i″ is less than or equal to n″ (S2418: YES), the processing proceeds to S2423. On the other hand, in a case where i″ is greater than n″ (S2418: NO), the processing proceeds to S2430.

In S2423, the third extraction portion 1203 calculates the total workload for the agents included in ai″ during the designated period.

Then, the third extraction portion 1203 determines whether the total workload is equal to or greater than the workload for the difficulty level “x” (S2424). In a case where the total workload is equal to or greater than the workload for the difficulty (S2424 YES), the processing proceeds to S2425. On the other hand, in a case where the total workload is less than the workload for the difficulty level “x” (S2424: NO), the processing proceeds to S2427.

In S2425, the third extraction portion 1203 adds the combination of ai″ to the third extraction result of the difficulty level “x”.

Then, the third extraction portion 1203 sets the available work flag to “1” (S2426).

Subsequently, the third extraction portion 1203 adds (increments) “1” to i″, and then the processing returns to S2418.

In S2430, the third extraction portion 1203 determines whether the available work flag is “1”. In a case where the available work flag is “1” (S2430: YES), the third extraction portion 1203 adds (increments) “1” to i (S2431), and then the processing returns to S2415. On the other hand, in a case where the available work flag is not “1” (S2430: NO), the third extraction portion 1203 adds (increments) “1” to i′ (S2431), and then the processing returns to S2418.

Returning to FIG. 21, the agent extraction section 120 then performs processing (hereinafter referred to as “fourth extraction result generation processing S2114”) of generating a fourth extraction result 174 based on the third extraction result (S2114).

FIG. 25 is a flowchart illustrating the fourth extraction result generation processing S2114. Hereinafter, the fourth extraction result generation processing S2114 will be described with reference to the drawing.

First, the agent extraction section 120 acquires the third extraction result for each difficulty level of the workload determination result 1802 in FIG. 18B (S2511).

Next, the agent extraction section 120 deletes, from all the third extraction results, records in which the agent organization ID does not exist in any of the third extraction results for any difficulty level (S2512).

Then, the agent extraction section 120 generates a record corresponding to each combination obtained by selecting one agent from each of the third extraction results for each difficulty level for each agent organization, and stores the generated record in the fourth extraction result 174 (S2513).

As described above, the matching support system 1 according to the second embodiment extracts agents by further considering the workload required to perform the service. Therefore, for example, it is possible to prevent an agent who is unable to handle the workload from being recommended and being turned down even in a case where a request is made to the agent. Further, the matching support system 1 according to the second embodiment is able to extract agents by considering the case where a service for one request is performed jointly by a plurality of agents (it is not necessary for the agent organizations to which the agents belong to be the same).

### Third Embodiment

In a case of matching between a client and a provider of a service, for example, an agent may wish to be able to select the client, for reasons such as not wanting to receive requests from clients with poor reputations or not wanting to receive requests from clients who may lead to trouble. In order to meet such needs of agents, the matching support system 1 according to the third embodiment further includes a mechanism for evaluating the client by the agent. Specifically, the matching support system 1 according to the third embodiment receives evaluations of the client from the agent, and does not recommend the pertinent agent to the client in a case where the client does not meet the level registered in advance by the agent.

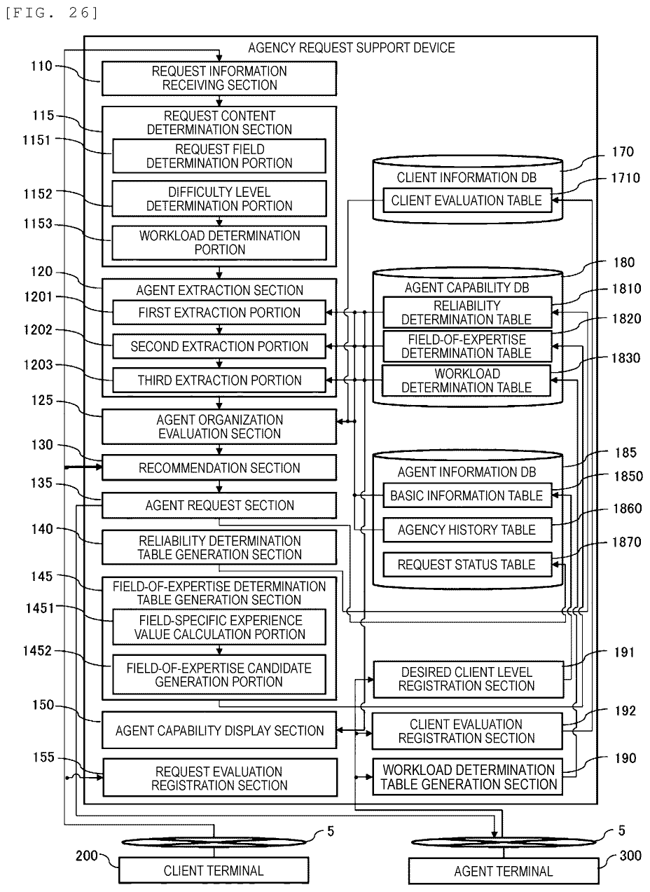

FIG. 26 is a diagram illustrating main functions of the agency request support device 100 in the matching support system 1 according to the third embodiment, which is configured based on the agency request support device 100 according to the second embodiment. The agency request support device 100 according to the third embodiment has basically the same functions as those of the agency request support device 100 according to the second embodiment, but has a configuration different from that of the agency request support device 100 according to the second embodiment in the following points.

First, the agency request support device 100 according to the third embodiment further has the functions of a client information DB 170, a desired client level registration section 191, and a client evaluation registration section 192. In addition, the client information DB 170 manages a client evaluation table 1710 in which the evaluation of the client by the agent is stored. Further, an item for storing the level of the client desired by the agent (hereinafter referred to as the “desired client level”) is added to the basic information table 1850 managed by the agent information DB 185 according to the third embodiment. Furthermore, the recommendation section 130 of the agency request support device 100 according to the third embodiment does not recommend a pertinent agent to a client who does not meet the agent's desired client level.

Among the functions of the agency request support device 100 according to the third embodiment, the desired client level registration section 191 receives the setting of a desired client level from the agent via the agent terminal 300, and stores the received desired client level in the basic information table 1850.

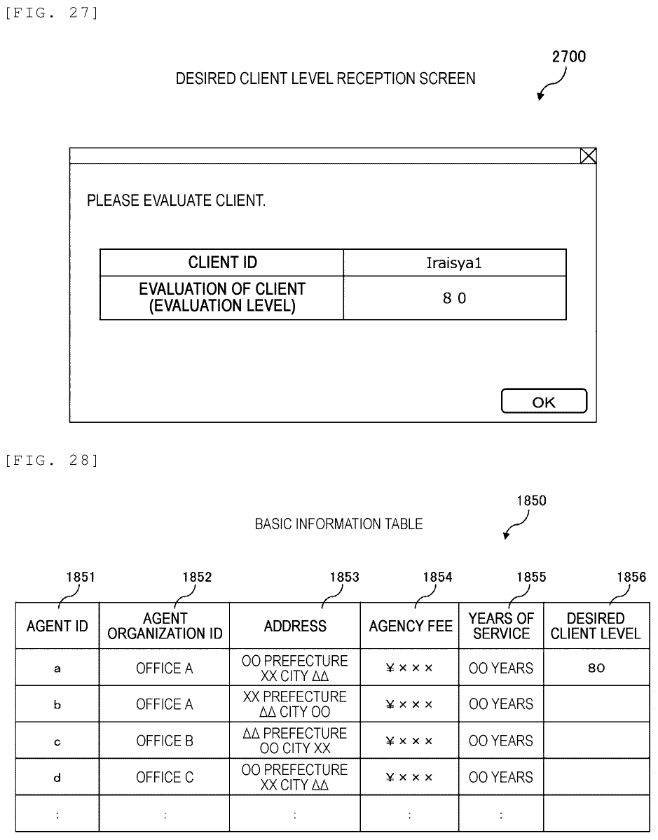

FIG. 27 illustrates an example of a screen (hereinafter referred to as the “desired client level reception screen 2700”) displayed by the agent terminal 300 in a case where the desired client level registration section 191 receives setting of the desired client level.

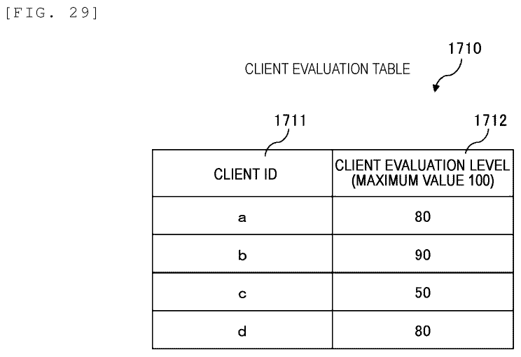

FIG. 28 illustrates an example of the basic information table 1850 according to the third embodiment. As illustrated in the drawing, the basic information table 1850 according to the third embodiment further has an item for desired client level 1856 in addition to the items described above.

The client evaluation registration section 192 illustrated in FIG. 26 receives setting of an evaluation of the client (hereinafter referred to as the “client evaluation level”) from the agent via the agent terminal 300, and registers the received contents in the client evaluation table 1710. It should be noted that in a case where the agent has received a plurality of requests from the same client in the past, the agent sets, for the client, for example, an average value of the evaluations of the client made for each of the past requests as the client evaluation level.

FIG. 29 illustrates an example of the client evaluation table 1710. As illustrated in the drawing, the client evaluation table 1710 includes one or more records having items of a client ID 1711 and a client evaluation level 1712. The client ID is stored in the client ID 1711. The client evaluation level is stored in the client evaluation level 1712.

The recommendation section 130 of the agency request support device 100 according to the third embodiment compares the desired client level 1856 in the basic information table 1850 with the client evaluation in the client evaluation table 1710. Then, even in a case where the agent extraction section 120 extracts an agent, the recommendation section 130 does not recommend the pertinent agent to the client who does not meet the desired client level of the pertinent agent.

As described above, the matching support system 1 according to the third embodiment receives evaluations of the client by the agent, and does not recommend the agent to the pertinent client in a case where the client does not meet the level registered in advance by the agent. Therefore, it is possible to respond to the desires of the agent, such as not wanting to receive requests from clients with poor reputations or not wanting to receive requests from clients who may lead to trouble.

The above description has been given of the case where the matching support system 1 according to the third embodiment is configured based on the agency request support device 100 according to the second embodiment. However, the matching support system 1 according to the third embodiment may be configured based on the agency request support device 100 according to the first embodiment in a similar manner.

Although the embodiments have been described above, the present invention is not limited to the above embodiments, and various modifications are included, and is not necessarily limited to those having all of the configurations described. Further, it is possible to replace a part of the configuration of a certain embodiment with the configuration of another embodiment, and it is also possible to add the configuration of another embodiment to the configuration of a certain embodiment. Furthermore, it is possible to add, remove, or replace other configurations with respect to a part of the configuration of each embodiment.

For example, the service that the client wants to receive from the provider of the service may be a service for financial institutions, infrastructure businesses (such as electric power companies, gas companies, and communication companies), hospitals, or the like. Further, examples of the service may include searching for and delivering information and services, confirming the authenticity of information, confirming consent in a case of using information, eliminating the complexity of various procedures, and the like.

### REFERENCE SIGNS LIST

1: matching support system
5: communication network
100: agency request support device
110: request information receiving section
115: request content determination section
1151: request field determination portion
1152: difficulty level determination portion
1153: workload determination portion
120: agent extraction section
1201: first extraction portion
1202: second extraction portion
1203: third extraction portion
125: agent organization evaluation section
130: recommendation section
135: agent request section
140: reliability determination table generation section
145: field-of-expertise determination table generation section
1451: field-specific experience value calculation portion
1452: field-of-expertise candidate generation portion
150: agent capability display section
155: request evaluation registration section
170: client information DB
1710: client evaluation table
180: agent capability DB
1801: difficulty level determination result
1802: workload determination result
1805: application form
1810: reliability determination table
1820: field-of-expertise determination table
1830: workload determination table
185: agent information DB
1850: basic information table
1860: agency history table
1870: request status table
190: workload determination table generation section
191: desired client level registration section
192: client evaluation registration section
200: client terminal
2700: desired client level reception screen
300: agent terminal

1. A matching support system that supports matching between a client and a provider of a service in a case where the client requests the provider of the service to provide the service, the matching support system
being configured by using an information processing apparatus having a processor and a storage device,
storing
basic information that is information about each of a plurality of the providers,
request information that is information about a request received from the client,
reliability that is information indicating a degree of reliability of each of the plurality of providers, and
information that indicates expertise of each of the providers for the service, and
comprising:
a difficulty level determination portion that determines a difficulty level of the request based on the request information;
a first extraction portion that extracts candidates of the providers of the service from the basic information so as to extract the provider having a higher reliability for the request having a higher difficulty level and that generates a first extraction result describing extracted results; and
a second extraction portion that extracts candidates of the providers of the service from the first extraction result so as to extract the provider having higher expertise in the service for the request having a higher difficulty level and that generates a second extraction result describing extracted results.

2. The matching support system according to claim 1,
wherein the reliability is calculated based on at least one of an experience level of the provider for each field of the service, the number of cases of the service provided, and a success rate of the service.

3. The matching support system according to claim 1,
wherein a level of the expertise is determined based on at least one of an experience level of the provider for each field of the service, the number of cases of the service provided for each field, evaluation of the client on the provided service, and a field of expertise received from the provider.

4. The matching support system according to claim 1, further comprising
a recommendation section that presents, to the client, the candidates of the providers based on the second extraction result via a user interface.

5. The matching support system according to claim 1,
wherein the matching support system further stores a schedule of available work time of each of the providers,
wherein the difficulty level determination portion determines a difficulty level for each element of the request,
wherein the matching support system further comprises a workload determination portion that calculates a workload for each difficulty level of the request,
wherein the first extraction portion generates the first extraction result for each difficulty level,
wherein the second extraction portion generates the second extraction result for each difficulty level, and
wherein the matching support system further comprises a third extraction portion that extracts a combination of the providers, each of which is capable of handling the workload for each difficulty level, in the second extraction result for each difficulty level and that generates a third extraction result describing the extracted combination.

6. The matching support system according to claim 5, further comprising
a recommendation section that presents, to the client, the candidates of the providers based on the third extraction result via a user interface.

7. The matching support system according to claim 5,
wherein the providers constituting the combination are included in combinations of providers belonging to different organizations.

8. The matching support system according to claim 4, further comprising:
a client evaluation registration section that receives and stores, from the provider, an evaluation of the client from whom a request is received in the past; and
a desired client level registration section that receives and stores, from the provider, a desired client level that is a threshold value of evaluation used to determine a desired client,
wherein the recommendation section does not present, to the client, a provider that does not meet the desired client level in the evaluation of the client, among the candidates of the providers based on the second extraction result.

9. The matching support system according to claim 6, further comprising:
a client evaluation registration section that receives and stores, from the provider, an evaluation of the client from whom a request is received in the past; and
a desired client level registration section that receives and stores, from the provider, a desired client level that is a threshold value of evaluation used to determine a desired client,
wherein the recommendation section does not present, to the client, a provider that does not meet the desired client level in the evaluation of the client, among the candidates of the providers based on the third extraction result.

10. A matching support method of supporting matching between a client and a provider of a service in a case where the client requests the provider of the service to provide the service,
wherein an information processing apparatus having a processor and a storage device executes:
a step of storing
basic information that is information about each of a plurality of the providers,
request information that is information about a request received from the client,
reliability that is information indicating a degree of reliability of each of the plurality of providers, and
information that indicates expertise of each of the providers for the service;
a step of determining a difficulty level of the request based on the request information;
a step of extracting candidates of the providers of the service from the basic information so as to extract the provider having a higher reliability for the request having a higher difficulty level and generating a first extraction result describing extracted results; and
a step of extracting candidates of the providers of the service from the first extraction result so as to extract the provider having higher expertise in the service for the request having a higher difficulty level and generating a second extraction result describing extracted results.

11. The matching support method according to claim 10,
wherein the information processing apparatus further executes a step of presenting, to the client, the candidates of the providers based on the second extraction result via a user interface.

12. The matching support method according to claim 10,
wherein the information processing apparatus further executes:
a step of further storing a schedule of available work time of each of the providers;
a step of determining a difficulty level for each element of the request;
a step of calculating a workload for each difficulty level of the request;
a step of generating the first extraction result for each difficulty level;
a step of generating the second extraction result for each difficulty level; and
a step of extracting a combination of the providers, each of which is capable of handling the workload for each difficulty level, in the second extraction result for each difficulty level and generating a third extraction result describing the extracted combination.

13. The matching support method according to claim 12,
wherein the information processing apparatus further executes a step of presenting, to the client, the candidates of the providers based on the third extraction result via a user interface.

14. The matching support method according to claim 11,
wherein the information processing apparatus further executes:
a step of receiving and storing, from the provider, an evaluation of the client from whom a request is received in the past;
a step of receiving and storing, from the provider, a desired client level that is a threshold value of evaluation used to determine a desired client; and
a step of not presenting, to the client, a provider that does not meet the desired client level in the evaluation of the client, among the candidates of the providers based on the second extraction result.

15. The matching support method according to claim 13,
wherein the information processing apparatus further executes:
a step of receiving and storing, from the provider, an evaluation of the client from whom a request is received in the past;
a step of receiving and storing, from the provider, a desired client level that is a threshold value of evaluation used to determine a desired client; and
a step of not presenting, to the client, a provider that does not meet the desired client level in the evaluation of the client, among the candidates of the providers based on the third extraction result.
